(19) United States
(12) Patent Application Publication
(10) Pub. No.: US 2026/0301370 A1
(43) Pub. Date: Oct. 1, 2026

(54) METHODS, STORAGE MEDIA, AND SYSTEMS FOR CLASSIFYING AN IMAGE ACCORDING TO AN INTENSITY OF AN OBJECT

(71) Applicant: Hover Inc., San Francisco, CA (US)

(72) Inventors: Zhiyao Xiong, San Mateo, CA (US); Harsh Barbhaiya, San Francisco, CA (US); Anish Sharma, San Jose, CA (US); Jeffrey Sommers, Los Altos Hills, CA (US)

(73) Assignee: Hover Inc., San Francisco, CA (US)

(21) Appl. No.: 19/475,717

(22) PCT Filed: Apr. 16, 2024
(86) PCT No.: PCT/US2024/024823

§ 371 Date: Oct. 15, 2025

Related U.S. Application Data
(60) Provisional application No. 63/496,590, filed on Apr. 17, 2023.
(60) Provisional application No. 63/532,971, filed on Aug. 16, 2023.
(60) Provisional application No. 63/634,433, filed on Apr. 15, 2024.

(51) Int. Cl. G06V 10/764; G06V 10/82; G06V 20/70

(52) U.S. Cl. CPC G06V 10/764; G06V 10/82; G06V 20/70

(57) ABSTRACT

Methods, systems, and storage medium for operating a graphics processing unit to evaluate the extent or degree that a real-world image comprises pixels representing a particular classification category are disclosed. The evaluation may involve evaluating a plurality of pixels in the real-world image according to a first classification category using a first layer of an inference network and at least one other classification category according to at least one other layer of the inference network, creating a first intra-layer value based on combining only the predicted values for one or more pixels of the real-world image as provided by the first layer, and classifying the real-world image according to the first intra-layer value. Post-evaluation operations such as training set generation, three-dimensional (3D) reconstruction, inferring un-evaluated classifications, image depth inference, and selective activation of communications with other processing units are disclosed.

### RELATED APPLICATIONS

This application claims priority to U.S. Provisional Patent Application No. 63/496,590 filed Apr. 17, 2023, titled “METHODS, STORAGE MEDIA, AND SYSTEMS FOR CLASSIFYING AN IMAGE FOR AN INTENSITY OF AN OBJECT,” and U.S. Provisional Patent Application No. 63/532,971 filed Aug. 16, 2023, titled “METHODS, STORAGE MEDIA, AND SYSTEMS FOR CLASSIFYING AN IMAGE FOR AN INTENSITY OF AN OBJECT,” and U.S. Provisional Patent Application No. 63/634,433 filed Apr. 15, 2024, titled “METHODS, STORAGE MEDIA, AND SYSTEMS FOR CLASSIFYING AN IMAGE FOR AN INTENSITY OF AN OBJECT,” all applications are also owned by the Applicant, and the contents of which are hereby incorporated by reference.

### BACKGROUND

Traditional semantic segmentation models predict a pixel value in an image according to and among trained classifications; a model may analyze a particular pixel for its likelihood of belonging to a certain classification. This invokes an analysis whereby a series of layers or indices predict the classification associated with a given layer at a particular pixel's location. In operation, when a particular pixel's classification is predicted, each layer makes a prediction reflecting the likelihood the particular pixel belongs to the classification associated with the particular layer, with the predicted values across all layers for the pixel summing to a value of 1. A function, such as an argmax function, may then identify which layer or index provided the highest value for the particular pixel, and select that layer's semantic label as the classification value at that pixel location.

Such a configuration may localize where in an image certain objects are likely to be, but require large computing resources across different processing centers to produce its output and forego other information of pixels the model may otherwise provide for the image. Furthermore, localization operations as typically performed for semantic segmentation occurs across multiple processing units, incurring additional computation times and limitations of a particular processing node. Graphics processing units (GPUs) and central processing units (CPUs) may complement each other to perform semantic segmentation, but each have disadvantages for generating outputs in real time.

### FIELD OF THE DISCLOSURE

The present disclosure relates to methods, storage media, and systems for using a single processing unit in classifying an image according to an intensity of a classified object using predicted values of pixels as evaluated by a single layer of an inference network.

### SUMMARY

Traditional semantic segmentation as practiced in the prior art is illustrated in FIG. 5A. An illustrative semantic segmentation inference network has a series of layers to predict which pixel locations depict two classes of objects, floors and ceilings as illustrated by the example, in an image. For simplicity of discussion in FIG. 5A and elsewhere throughout the disclosure, the illustrated image has a low resolution of 2×2 pixels. In the floor layer, designated as index n=0, the inference network predicts whether each pixel comprises visual data indicative of a floor. Values closer to 1 indicate a high likelihood the pixel represents visual information associated with a floor, and values closer to 0 indicate a high likelihood the pixel does not represent visual information associated with a floor. Similarly for the ceiling layer, designated as index n=1, values closer to 1 indicate a high likelihood the pixel represents visual information associated with a ceiling, and values closer to 0 indicate a high likelihood the pixel does not represent visual information associated with a ceiling. It will be appreciated that in operation, the layers or indices operate in conjunction with one another when making a prediction. Any pixel's value is configured to sum, across all layers at a similar pixel location, to a value of 1. Each layer therefore predicts the relative likelihood a pixel represents a classification, relative to the prediction of other layers for that same index.

As illustrated in FIG. 5A, an argmax function typically then operates across the layers to make an overall prediction for each pixel by identifying which index has the highest value for a given pixel. As such, the argmax function produces a two-dimensional output array corresponding to the number of pixels of resolution of the input image. FIG. 5A illustrates this output array with the top two pixels assigned to index 1 (the ceiling layer) and the lower two pixels are assigned to index 0 (the floor layer). This is because, as illustrated, index 1 had higher prediction values in its layer for the top two pixels as compared to the other layer's predicted values for those same pixels, and index O had higher values in its layer for the bottom two pixels as compared to the other layer's predicted values for those same pixels. This argmax output can then be used as a semantic representation: each pixel location may be visually represented according to a visual cue associated with the classification, resulting in a prediction and display of where a classified object (e.g., floor or ceiling) appears in the image.

Argmax functions inherently are performed on a central processing unit (CPU), which may perform a variety of functions but itself consumes longer computation times and larger energy as compared to graphics processing units (GPUs) which generally performs narrower functions but at higher speeds and lower energy. Additionally, data transfers between CPUs and GPUS invoke additional time and computational cycles when processing images. This affects the applicability of traditional segmentation models on high resolution images or in real time applications. While the GPU may be configured to make layer-specific predictions for pixels quickly, additional operations like selecting a value for a pixel according to a multi-layer analysis is performed by the slower CPU. The CPU timing limitation delays actions and can overheat devices by the additional resources it uses, or force down sampling of application speeds to preserve power or manage consumption. Experimental data related to the techniques described herein indicates that a traditional segmentation model operating in the manner of FIG. 5A may take as many as 500 ms per image frame to semantically segment or otherwise classify images in this way.

In some embodiments of the present invention, semantic evaluation is altered to allow all processing on a GPU. This novel configuration is motivated by the technical limitations of a GPU or CPU, or the cost of their inter-component communication: to improve speed, all processing is performed on a GPU and to generate usable data from a GPU-only operation a new data type is created by way of a classification relative intensity. These techniques implement an inference network (that was trained to perform traditional semantic segmentation) in a novel way to make use of individual layers' data to draw new data insights.

In some embodiments, instead of operations to pool and analyze data across layers, intra-layer pooling operations are performed. In some embodiments, intra-layer pooling combines pixel values within a given layer, such as by summing some or all pixel's predicted values for a layer, to provide an aggregate intra-layer value for the classification of that layer. In some embodiments, the number of pixels input to determine an intra-layer value is the number of pixels for the image frame on the whole. In some embodiments, the number of pixels input to determine an intra-layer value is the number of pixels in the layer with a predicted value greater than 1/n (where n is the number of layers of the inference network). In some embodiments, the number of pixels input to determine an intra-layer value is the number of pixels in the layer with a value equal to or greater than 0.5.

Because a pixel's predicted value according to any one layer is based on the pixel's predicted value according to other layers (recall in FIG. 5A that across all layers, the layers' pixel values sum to a value of 1), the combined predicted value for all pixels in a given layer reflects the likelihood that the classified object associated with that layer is in the image relative to the likelihood the image depicts objects belonging to other layer's classifications. In other words, a relative intensity of the classification within the image may be read according to individual layers; the combined predicted values from any one layer indicate the comparative probability the classified object is in the image. For the illustration of FIG. 5A, if this configuration were applied there this relative intensity may indicate the likelihood that the image depicts a floor, or that a ceiling is in the image.

In some embodiments, this is further processed into an intensity score for the layer by further adjusting the intra-level value (which reflects a relative intensity as described above) into an intensity score for the layer, the intensity scores provides a measure of the relative intensity in light of instant parameters of the image or the inference network. For example, as a network has an increasing number of layers, lesser relative intensity for any one layer (as expressed by an intra-layer value) should have lower comparable value as to true scene information. Similarly, for lower resolution images, lesser relative intensity for any one layer (as expressed by an intra-layer value) should have lower comparable value as to true scene information. In either case, the layers with higher intensity scores are more likely to provide information that better describes the image on the whole.

In some embodiments, the intensity score divides the intra-layer value by a number of pixels in the image frame. In some embodiments, the number of pixels is the number of pixels for the image frame on the whole. In some embodiments, the intensity score divides the intra-layer value by a number of layers in the inference network.

As described herein, predicted pixel values are thus aggregated or determined for a particular layer; this provides an indication of the likelihood, or degree, of the layer's classified object appearing anywhere in the image frame, as opposed to attempting to determine the likelihood that any one pixel is exclusively associated with a particular classification or another classification as analyzed by another layer, and foregoing the localization and maximum function compared with other layers on a pixel-wise basis that requires the CPU to perform.

Further, each layer may be leveraged to produce as many intra-layer values as there are layers. This may provide multiple indicators for a variety of intensities of classified objects, and serve as new classification values for the image. Broadly speaking and using a simple classification example, instead of a network predicting “this pixel is probably a cat” the network could determine “this image has an appreciable amount of cat pixels based on the image and network parameters.”

A layer-specific score, such as an intra-layer value, can satisfy a simpler search function of whether the classification is true for the image on the whole, rather than where in the image the classification is true. In other words, a visual representation of the segmentation does not need to be produced. Detection functions that only need to validate if a classified object is in an image, or is sufficiently represented in an image, can rely on the intra-layer pooling described herein. For example, to generate training data for an object detection network, a large quantity of images for the object would be desired and a diversity of image quality would be desired to prevent under-or over-fitting. An object detection network to identify a cat in an image would want not merely a large number of cat images to train on, but also particular types of cat images such as ones that only partially contain cats and also no cats to make robust detections. A segmentation intensity network as described herein could respond to various intensity criteria to build appropriate training sets.

In another use case, image selection or collection in real time for post-capture operations can benefit from the disclosed techniques. For three-dimensional reconstruction, input image quality influences the quality of the resultant model. Images with few features are less valuable than images with multiple features, and perspective images (images showing an object from an angle) provide valuable three-dimensional information about the object, scene, or camera pose. A segmentation intensity network as described herein can indicate when an image frame has a sufficient amount of pixel information for a desired classification without expending additional resources or complicating image capture to determine where in the image such classification is, which is a function that needs to be leveraged later and not at capture.

For example, using three-dimensional reconstruction of a room from images taken within the room as an illustration, images that depict both a ceiling and a floor comprise valuable visual information. The presence of these two types of surfaces in a single image suggests the image depicts helpful perspective information; both ceilings and floors meet at walls, by detecting both a ceiling and a floor in an image it is likely the image depicts planar intersections or corners. Additionally, if an image depicts both a ceiling and a floor, it is likely the camera that captured the image has a sufficient scene depth to observe other helpful features for three-dimensional reconstruction, such as features for SiFT or other detection and matching algorithms for determining a camera pose based on its visual information.

In some embodiments, the intra-layer score (either the intra-layer value or the intensity score) is provided to a data structure. In some embodiments, the data structure is an output layer of a one-dimensional array (e.g., a 1 x n matrix), where n is the number of classification layers. Each cell of the data structure is populated by a respective layer's score. This produces a data label, or new classification, for the image frame indicative of the detection for classified objects in the image frame. By shifting to a detection-centric output, either at the classification layer level or at the data structure layer combining multiple classification layer scores, as opposed to a display-centric output that requires a localization and maximization function of a pixel likelihood, such as by an argmax function, all computations may be performed on a GPU. Experimental data related to the techniques described herein indicates that a detection-centric model may take as little as 60 ms per image frame to merely detect the presence of a particular classified object. This not only permits real time application of the detection network, but also frees up computational power to perform additional tasks relative to the 500 ms operations required to identify which particular pixel classifications were most dominant for the plurality of pixels in the image. In other words, by using the techniques described herein each pixel need not be specifically classified but rather each layer's classification is approximately assessed.

In some embodiments, a multi-class detection network such as the one described herein may be used to infer non-detected geometries. In computer vision pipelines, images with perspective views of captured geometry (e.g. those with depth perspective) provide valuable cues for functions such as simultaneous localization and mapping (SLAM) or three-dimensional (3D) reconstruction. Corners are valuable geometries in such pipelines for the angular perspectives and depths cues they provide. A multi-class detection network that detects floors and ceilings can infer the presence of corners within the image; if a ceiling is present in an image as well as a floor, it can be inferred that a wall connects them and ceilings or floors meet walls at corners. Though walls can meet at corners too, a classification network that simply identifies a single classification for walls would be less able to detect the presence of a corner (orientation of a particular wall relative to another wall would not be detected by a pixel classification).

Additionally, detecting both ceiling and floors ensures an image is taken from far enough away of a respective object to collect actionable data. An image taken from 10 inches from a wall is unlikely to provide much useful data for a computer vision pipeline as compared to an image taken 10 feet away from that same wall. Detecting surfaces separated by intermediate geometry (such as floors and ceilings are reasonably separated by walls) suggests the camera pose was far enough away to capture relevant images of the scene.

Accordingly, various problems are solved by embodiments disclosed herein. The problem of CPU processing limitations in segmentation operations is solved by implementing layer-specific detection operations on a GPU. The problem of detecting geometries defined by multiple possible configurations is solved by detecting a subset of distinct components.

Advantageously, the techniques described herein may leverage pre-existing networks to produce new outputs. For example, a segmentation network that was trained to generate a multi-classification output predicting a single pixel's value according to a single classification may instead be deployed to leverage its underlying layers to assess the presence or intensity of an object in that image according to that associated object's layer in the network. This changes the network's function of determining the likelihood that any one pixel of a real-world image represents a particular classification, and instead determines the likelihood that the image frame on the whole comprises the particular classification. In cases where an inference network may dismiss a particular pixel's value according to one classification layer in favor of another, embodiments as described herein may leverage an otherwise dismissed pixel value to assess an overall attribute for the real-world image frame.

In some embodiments, because of the computing savings enabled by intra-layer evaluation for intensity of a classified object in an image, a method of communicating between processing components is enabled. In some embodiments, interactions with a CPU are not initialized until a satisfactory intensity score for a particular classification of an object is calculated by a GPU. A specific method of communicating among CPU and GPU components is enabled that requires a segmentation layer's intra-layer value for a classification intensity exceeds a value as a necessary condition for activating a CPU or other localization processing. By doing so, the higher resource consumption of a CPU is selectively activated when certain classifications are detected by a lower resource tool like a GPU.

One aspect of the present disclosure relates to a method for classifying an image for an intensity of an object. The method may include segmenting a plurality of pixels in the image according to a first classification using a first layer of an inference network. The method may include segmenting the plurality of pixels in the image according to a second classification using a second layer of an inference network. The method may include aggregating a first pooled value consisting of the segmentation of one or more pixels relative to the first classification in the first layer. The method may include aggregating a second pooled value consisting of the segmentation of one or more pixels relative to the second classification in the second layer. The method may include combining the first pooled value with the second pooled value. The method may include providing one or more multiple-class intensity scores for the image using the combined first pooled value and second pooled value. The method may include storing the image when the first pooled value is less than or equal to the second pooled value.

Another aspect of the present disclosure relates to a non-transient computer-readable storage medium having instructions embodied thereon, the instructions being executable by one or more processors to perform a method for classifying an image for an intensity of an object. The method may include segmenting a plurality of pixels in the image according to a first classification using a first layer of an inference network. The method may include segmenting the plurality of pixels in the image according to a second classification using a second layer of an inference network. The method may include aggregating a first pooled value consisting of the segmentation of one or more pixels relative to the first classification in the first layer. The method may include aggregating a second pooled value consisting of the segmentation of one or more pixels relative to the second classification in the second layer. The method may include combining the first pooled value with the second pooled value. The method may include providing one or more multiple-class intensity scores for the image using the combined first pooled value and second pooled value. The method may include storing the image when the first pooled value is less than or equal to the second pooled value.

Yet another aspect of the present disclosure relates to a system configured for classifying an image for an intensity of an object. The system may include one or more hardware processors configured by machine-readable instructions. The processor(s) may be configured to segment a plurality of pixels in the image according to a first classification using a first layer of an inference network. The processor(s) may be configured to segment the plurality of pixels in the image according to a second classification using a second layer of an inference network. The processor(s) may be configured to aggregate a first pooled value consisting of the segmentation of one or more pixels relative to the first classification in the first layer. The processor(s) may be configured to aggregate a second pooled value consisting of the segmentation of one or more pixels relative to the second classification in the second layer. The processor(s) may be configured to combine the first pooled value with the second pooled value. The processor(s) may be configured to provide one or more multiple-class intensity scores for the image using the combined first pooled value and second pooled value. The processor(s) may be configured to store the image when the first pooled value is less than or equal to the second pooled value.

One aspect of the present disclosure relates to a method for classifying an image for an intensity of an object. The method may include segmenting a plurality of pixels in the image according to a first classification using a first layer of an inference network. The method may include aggregating a first pooled value consisting of the segmentation of one or more pixels relative to the first classification in the first layer. The method may include providing the first pooled value to a matrix having at least one element attributable to the first pooled value. The method may include providing an intensity score for the image based on the first pooled value of the matrix. The method may include storing the image when the first pooled value is less than or equal to a second pooled value.

Another aspect of the present disclosure relates to a non-transient computer-readable storage medium having instructions embodied thereon, the instructions being executable by one or more processors to perform a method for classifying an image for an intensity of an object. The method may include segmenting a plurality of pixels in the image according to a first classification using a first layer of an inference network. The method may include aggregating a first pooled value consisting of the segmentation of one or more pixels relative to the first classification in the first layer. The method may include providing the first pooled value to a matrix having at least one element attributable to the first pooled value. The method may include providing an intensity score for the image based on the first pooled value of the matrix. The method may include storing the image when the first pooled value is less than or equal to a second pooled value.

Yet another aspect of the present disclosure relates to a system configured for classifying an image for an intensity of an object. The system may include one or more hardware processors configured by machine-readable instructions. The processor(s) may be configured to segment a plurality of pixels in the image according to a first classification using a first layer of an inference network. The processor(s) may be configured to aggregate a first pooled value consisting of the segmentation of one or more pixels relative to the first classification in the first layer. The processor(s) may be configured to provide the first pooled value to a matrix having at least one element attributable to the first pooled value. The processor(s) may be configured to provide an intensity score for the image based on the first pooled value of the matrix. The processor(s) may be configured to store the image when the first pooled value is less than or equal to a second pooled value.

Yet another aspect of the present disclosure relates to methods for using a graphics processing unit to evaluate a real-world image for a degree that pixels in the real-world image represent a particular classification category. The method may include evaluating a plurality of pixels in the real-world image according to a first classification category using a first layer of an inference network and at least one other classification category according to at least one other layer of the inference network, wherein the inference network is configured to predict a single classification for each pixel among all layers' evaluations. The method may include creating a first intra-layer value based on summing inputs consisting of predicted values for one or more pixels of the real-world image by the first layer, wherein a predicted value for any one pixel of the plurality of pixels by the first layer is based on a relative comparison of the evaluation of the pixel by the first layer of the inference network relative to the evaluation of the same pixel by the at least one other layer. The method may include classifying the real-world image according to the first intra-layer value. An intra-layer value may represent an intensity of objects within the real-world image that match an associated layer's classification as compared to other classifications associated with other layers of the inference network.

In some aspects, the method may include creating a second intra-layer value based on inputs consisting of predicted values for one or more pixels of the real-world image by one of the at least one other layers, wherein a predicted value for any one pixel of the plurality of pixels by the one of the at least one other layer is based on a relative comparison of the evaluation of the pixel by the one of the at least one other layer of the inference network relative to the evaluation of the same pixel by the first layer. The method may include classifying the real-world image according to both the first and second intra-layer value. The method may include selecting the real-world image for three-dimensional reconstruction responsive to the first and second intra-layer values. The method may include using layers within the inference network that have classification categories related to one another, such as belong to a common genus like building object geometries or attributes (like floor surfaces, ceiling surfaces, and the like). The method may include inferring the presence of objects that are not associated with a particular layer of the inference network, such as detecting corners when certain planar surfaces are detected by their respective layers. The method may include validating a camera position or depth metric relative to detected objects by particular layers, such as determining the camera that captured the real-world image is a sufficient distance objects in the scene to enable additional image processing techniques such as three-dimensional (3D) reconstruction using the real-world image. The method may include providing the first or second intra-layer value to a data array, or may combine the first and second intra-layer value into a multi-cell data array based on the number of intra-layer values produced by the method and the data array itself is a new classification for the real-world image. The method may include creating an intensity score that describes or qualifies an intra-layer value according to a parameter such as one of a real-world image (e.g. a number of pixels in the image) or one of the inference network (e.g. a number of layers for the network).

In yet another aspect, a method is described for using an intra-layer value as provided from predicted values of a particular layer within an inference network to identify images suitable for creating a training image set for configuring an inference network, either additional tuning for the inference network used to generate the intra-layer value, or an additional network for additional purposes as designed for.

In yet another aspect, a method is described for initiating communication with a CPU to perform more complicated operations than the GPU is configured to perform, such as semantic segmentation, in response to an image frame satisfying an intra-layer value or intensity score.

Yet another aspect relates to a system for using a graphics processing unit to evaluate a real-world image for a degree that pixels in the real-world image represent a particular classification category. The system may include memory or one or more processing units that are configured to evaluate a plurality of pixels in the real-world image according to a first classification category using a first layer of an inference network and at least one other classification category according to at least one other layer of the inference network, wherein the inference network is configured to predict a single classification for each pixel among all layers' evaluations. The system may be configured to create a first intra-layer value based on summing inputs consisting of predicted values for one or more pixels of the real-world image by the first layer, wherein a predicted value for any one pixel of the plurality of pixels by the first layer is based on a relative comparison of the evaluation of the pixel by the first layer of the inference network relative to the evaluation of the same pixel by the at least one other layer. The system may be configured to classify the real-world image according to the first intra-layer value. An intra-layer value may represent an intensity of objects within the real-world image that match an associated layer's classification as compared to other classifications associated with other layers of the inference network.

Another aspect of the present disclosure relates to a non-transient computer-readable storage medium having instructions embodied thereon, the instructions being executable by one or more processors to perform a method for using a graphics processing unit to evaluate a real-world image for a degree that pixels in the real-world image represent a particular classification category. The method may include evaluating a plurality of pixels in the real-world image according to a first classification category using a first layer of an inference network and at least one other classification category according to at least one other layer of the inference network, wherein the inference network is configured to predict a single classification for each pixel among all layers' evaluations. The method may include creating a first intra-layer value based on summing inputs consisting of predicted values for one or more pixels of the real-world image by the first layer, wherein a predicted value for any one pixel of the plurality of pixels by the first layer is based on a relative comparison of the evaluation of the pixel by the first layer of the inference network relative to the evaluation of the same pixel by the at least one other layer. The method may include classifying the real-world image according to the first intra-layer value. An intra-layer value may represent an intensity of objects within the real-world image that match an associated layer's classification as compared to other classifications associated with other layers of the inference network.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for classifying an image for an intensity of an object, or for evaluating an image for an intensity or degree that pixels in an image represent a particular classification category, according to some embodiments.

FIG. 2 illustrates a method for classifying an image for an intensity of an object, according to some embodiments.

FIG. 3 illustrates a system configured for classifying an image for an intensity of an object, according to some embodiments.

FIG. 4 illustrates a method for classifying an image for an intensity of an object, according to some embodiments.

FIG. 5A illustrates an exemplary embodiment of the prior art for a semantic segmentation network.

FIGS. 5B-5C illustrate an inference architecture for predicting a presence or intensity of a classified object indicated by a particular layer of an inference network associated with the classified object according to some embodiments.

FIG. 6 illustrates a method for evaluating or determining a degree of pixels in a real-world image according to a derived intra-layer value according to some embodiments.

FIGS. 7A-7C illustrate post-evaluation operations enabled by intra-layer value derivation from a real-world object according to some embodiments.

FIG. 8 illustrates a system configured for evaluating an image for an intensity or degree that pixels in an image represent a particular classification category according to some embodiments.

### DETAILED DESCRIPTION

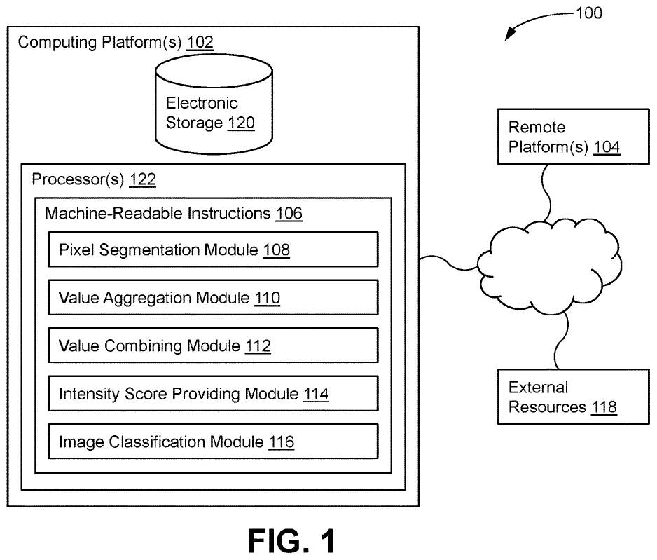

FIG. 1 illustrates a system 100 configured for classifying an image for an intensity of an object, in accordance with one or more implementations. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction modules. The instruction modules may include computer program modules. The instruction modules may include one or more of pixel segmentation module 108, value aggregation module 110, value combining module 112, intensity score providing module 114, image storing module 116, and/or other instruction modules.

Pixel segmentation module 108 may be configured to segment a plurality of pixels in the image according to a first classification using a first layer of an inference network. The first classification may be a first surface. The first surface may be a floor. The first surface may be a ground surface. The first surface may be a ceiling.

The first surface may be a roof facet.

Pixel evaluation module 108 may be configured to segment the plurality of pixels in the image according to a second classification using a second layer of an inference network. The second classification may be a second surface. The second surface may be a ceiling. The second surface may be a roof facet. The second surface may be a floor.

The second surface may be a ground surface.

Value aggregation module 110 may be configured to aggregate a first pooled value consisting of the segmentation of one or more pixels relative to the first classification in the first layer. Providing the one or more multiple-class intensity scores may further include modifying the first pooled value based on the number of pixels in the image. Modifying the first pooled value may include dividing the first pooled value by the number of pixels in the image.

Value aggregation module 110 may be configured to aggregate a second pooled value consisting of the segmentation of one or more pixels relative to the second classification in the second layer. Combining the first pooled value with the second pooled value may include respectively populating a matrix including elements for at least the first pooled value and the second pooled value. Providing the one or more multiple-class intensity scores may further include modifying the second pooled value based on the number of pixels in the image.

Value combining module 112 may be configured to combine the first pooled value with the second pooled value.

Intensity score providing module 114 may be configured to provide one or more multiple-class intensity scores for the image using the combined first pooled value and second pooled value. Modifying the second pooled value may include dividing the second pooled value by the number of pixels in the image.

Image storing module 116 may be configured to store the image when the first pooled value is less than or equal to the second pooled value.

In some implementations, each of the segmenting and combining may be performed on a graphics processing unit.

In some implementations, computing platform(s) 102, remote platform(s) 104, and/or external resources 120 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 120 may be operatively linked via some other communication media.

A given remote platform 104 may include one or more processors configured to execute computer program modules. The computer program modules may be configured to enable an expert or user associated with the given remote platform 104 to interface with system 100 and/or external resources 120, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 120 may include sources of information outside of system 100, external entities participating with system 100, and/or other resources. In some implementations, some or all of the functionality attributed herein to external resources 120 may be provided by resources included in system 100.

Computing platform(s) 102 may include electronic storage 120, one or more processors 122, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 120 may comprise non-transitory storage media that electronically stores information. The electronic storage media of electronic storage 120 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 120 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 120 may include one or more virtual storage resources (e.g., cloud storage, a virtual private network, and/or other virtual storage resources). Electronic storage 120 may store software algorithms, information determined by processor(s) 122, information received from computing platform(s) 102, information received from remote platform(s) 104, and/or other information that enables computing platform(s) 102 to function as described herein.

Processor(s) 122 may be configured to provide information processing capabilities in computing platform(s) 102. As such, processor(s) 122 may include one or more of a digital processor, an analog processor, a digital circuit designed to process information, an analog circuit designed to process information, a state machine, and/or other mechanisms for electronically processing information. Although processor(s) 122 is shown in FIG. 1 as a single entity, this is for illustrative purposes only. In some implementations, processor(s) 122 may include a plurality of processing units. These processing units may be physically located within the same device, or processor(s) 122 may represent processing functionality of a plurality of devices operating in coordination. Processor(s) 122 may be configured to execute modules 108, 110, 112, 114, and/or 116, and/or other modules. Processor(s) 122 may be configured to execute modules 108, 110, 112, 114, and/or 116, and/or other modules by software; hardware; firmware; some combination of software, hardware, and/or firmware; and/or other mechanisms for configuring processing capabilities on processor(s) 122. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, and/or 116 are illustrated in FIG. 1 as being implemented within a single processing unit, in implementations in which processor(s) 122 includes multiple processing units, one or more of modules 108, 110, 112, 114, and/or 116 may be implemented remotely from the other modules. The description of the functionality provided by the different modules 108, 110, 112, 114, and/or 116 described below is for illustrative purposes, and is not intended to be limiting, as any of modules 108, 110, 112, 114, and/or 116 may provide more or less functionality than is described. For example, one or more of modules 108, 110, 112, 114, and/or 116 may be eliminated, and some or all of its functionality may be provided by other ones of modules 108, 110, 112, 114, and/or 116. As another example, processor(s) 122 may be configured to execute one or more additional modules that may perform some or all of the functionality attributed below to one of modules 108, 110, 112, 114, and/or 116.

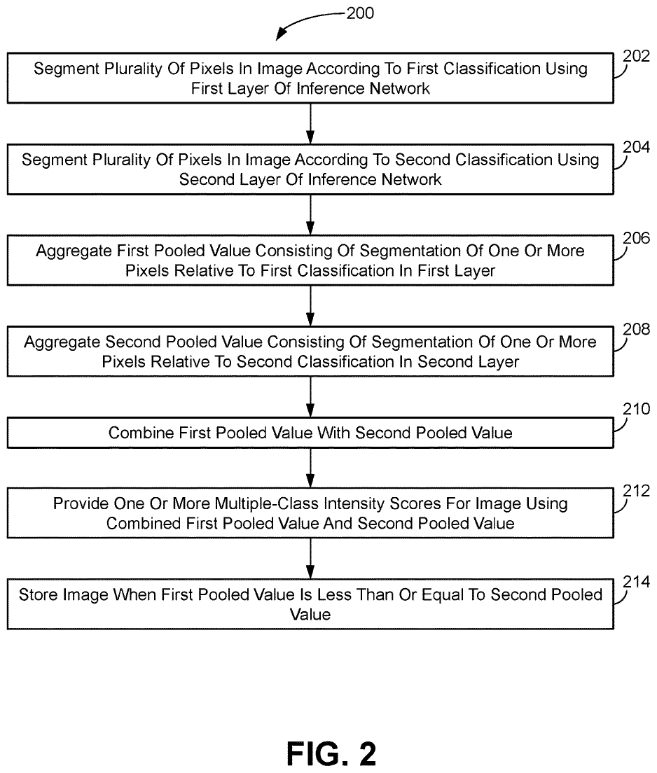

FIG. 2 illustrates a method 200 for classifying an image for an intensity of an object, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include segmenting a plurality of pixels in the image according to a first classification using a first layer of an inference network. Operation 202 may be performed by one or more hardware processors configured by machine-readable instructions including a module that is the same as or similar to pixel segmentation module 108, in accordance with one or more implementations.

An operation 204 may include segmenting the plurality of pixels in the image according to a second classification using a second layer of an inference network. Operation 204 may be performed by one or more hardware processors configured by machine-readable instructions including a module that is the same as or similar to pixel segmentation module 108, in accordance with one or more implementations.

An operation 206 may include aggregating a first pooled value consisting of the segmentation of one or more pixels relative to the first classification in the first layer. Operation 206 may be performed by one or more hardware processors configured by machine-readable instructions including a module that is the same as or similar to value aggregation module 110, in accordance with one or more implementations.

An operation 208 may include aggregating a second pooled value consisting of the segmentation of one or more pixels relative to the second classification in the second layer. Operation 208 may be performed by one or more hardware processors configured by machine-readable instructions including a module that is the same as or similar to value aggregation module 110, in accordance with one or more implementations.

An operation 210 may include combining the first pooled value with the second pooled value. Operation 210 may be performed by one or more hardware processors configured by machine-readable instructions including a module that is the same as or similar to value combining module 112, in accordance with one or more implementations.

An operation 212 may include providing one or more multiple-class intensity scores for the image using the combined first pooled value and second pooled value. Operation 212 may be performed by one or more hardware processors configured by machine-readable instructions including a module that is the same as or similar to intensity score providing module 114, in accordance with one or more implementations.

An operation 214 may include storing the image when the first pooled value is less than or equal to the second pooled value. Operation 214 may be performed by one or more hardware processors configured by machine-readable instructions including a module that is the same as or similar to image storing module 116, in accordance with one or more implementations.

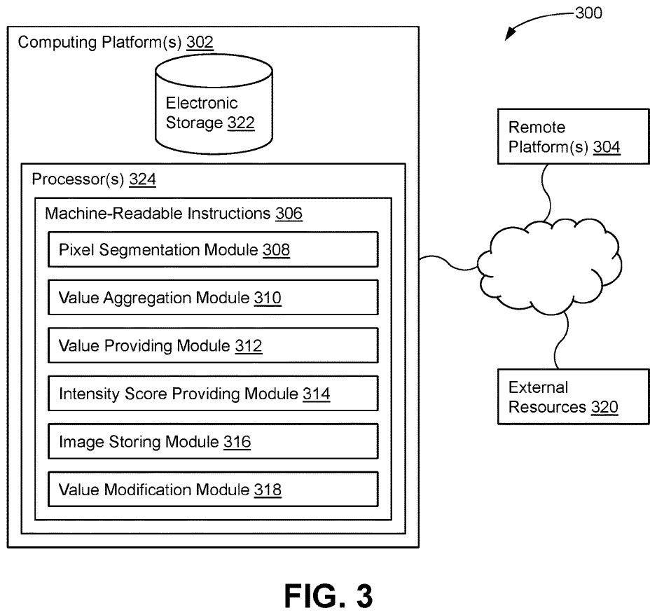

FIG. 3 illustrates a system 300 configured for classifying an image for an intensity of an object, in accordance with one or more implementations. In some implementations, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304.

Computing platform(s) 302 may be configured by machine-readable instructions 306. Machine-readable instructions 306 may include one or more instruction modules. The instruction modules may include computer program modules. The instruction modules may include one or more of pixel segmentation module 308, value aggregation module 310, value providing module 312, intensity score providing module 314, image storing module 316, value modification module 318, and/or other instruction modules.

Pixel segmentation module 308 may be configured to segment a plurality of pixels in the image according to a first classification using a first layer of an inference network. The first classification may be a first surface. The first surface may be a floor. The first surface may be a ground surface. The first surface may be a ceiling.

The first surface may be a roof facet.

Pixel segmentation module 308 may be configured to segment the plurality of pixels in the image according to a second classification using a second layer of an inference network. Each of the segmenting and providing steps may be performed on a graphics processing unit. The second classification may be a second surface. The second surface may be a ceiling. The second surface may be a roof facet.

The second surface may be a floor. The second surface may be a ground surface.

Value aggregation module 310 may be configured to aggregate a first pooled value consisting of the segmentation of one or more pixels relative to the first classification in the first layer. Modifying the first pooled value may include dividing the first pooled value by the number of pixels in the image.

Value providing module 312 may be configured to provide the first pooled value to a matrix having at least one element attributable to the first pooled value.

Value providing module 312 may be configured to provide the second pooled value to the matrix. The matrix may further include at least one additional element attributable to the second pooled value.

Intensity score providing module 314 may be configured to provide an intensity score for the image based on the first pooled value of the matrix.

Image storing module 316 may be configured to store the image when the first pooled value is less than or equal to a second pooled value. The second pooled value may be an aggregation consisting of the segmentation of one or more pixels relative to the second classification in the second layer. Modifying the second pooled value may include dividing the second pooled value by the number of pixels in the image.

Value modification module 318 may be configured to modify the first pooled value based on the number of pixels in the image.

Value modification module 318 may be configured to modify the second pooled value based on the number of pixels in the image.

In some implementations, computing platform(s) 302, remote platform(s) 304, and/or external resources 320 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 320 may be operatively linked via some other communication media.

A given remote platform 304 may include one or more processors configured to execute computer program modules. The computer program modules may be configured to enable an expert or user associated with the given remote platform 304 to interface with system 300 and/or external resources 320, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 320 may include sources of information outside of system 300, external entities participating with system 300, and/or other resources. In some implementations, some or all of the functionality attributed herein to external resources 320 may be provided by resources included in system 300.

Computing platform(s) 302 may include electronic storage 322, one or more processors 324, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 322 may comprise non-transitory storage media that electronically stores information. The electronic storage media of electronic storage 322 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 322 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 322 may include one or more virtual storage resources (e.g., cloud storage, a virtual private network, and/or other virtual storage resources). Electronic storage 322 may store software algorithms, information determined by processor(s) 324, information received from computing platform(s) 302, information received from remote platform(s) 304, and/or other information that enables computing platform(s) 302 to function as described herein.

Processor(s) 324 may be configured to provide information processing capabilities in computing platform(s) 302. As such, processor(s) 324 may include one or more of a digital processor, an analog processor, a digital circuit designed to process information, an analog circuit designed to process information, a state machine, and/or other mechanisms for electronically processing information. Although processor(s) 324 is shown in FIG. 3 as a single entity, this is for illustrative purposes only. In some implementations, processor(s) 324 may include a plurality of processing units. These processing units may be physically located within the same device, or processor(s) 324 may represent processing functionality of a plurality of devices operating in coordination. Processor(s) 324 may be configured to execute modules 308, 310, 312, 314, 316, and/or 318, and/or other modules. Processor(s) 324 may be configured to execute modules 308, 310, 312, 314, 316, and/or 318, and/or other modules by software; hardware; firmware; some combination of software, hardware, and/or firmware; and/or other mechanisms for configuring processing capabilities on processor(s) 324. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, 316, and/or 318 are illustrated in FIG. 3 as being implemented within a single processing unit, in implementations in which processor(s) 324 includes multiple processing units, one or more of modules 308, 310, 312, 314, 316, and/or 318 may be implemented remotely from the other modules. The description of the functionality provided by the different modules 308, 310, 312, 314, 316, and/or 318 described below is for illustrative purposes, and is not intended to be limiting, as any of modules 308, 310, 312, 314, 316, and/or 318 may provide more or less functionality than is described. For example, one or more of modules 308, 310, 312, 314, 316, and/or 318 may be eliminated, and some or all of its functionality may be provided by other ones of modules 308, 310, 312, 314, 316, and/or 318. As another example, processor(s) 324 may be configured to execute one or more additional modules that may perform some or all of the functionality attributed below to one of modules 308, 310, 312, 314, 316, and/or 318.

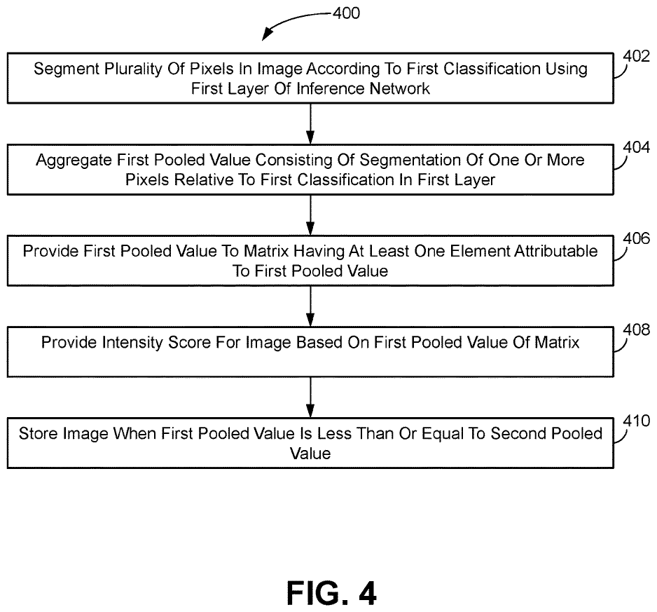

FIG. 4 illustrates a method 400 for classifying an image for an intensity of an object, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

An operation 402 may include segmenting a plurality of pixels in the image according to a first classification using a first layer of an inference network. Operation 402 may be performed by one or more hardware processors configured by machine-readable instructions including a module that is the same as or similar to pixel segmentation module 308, in accordance with one or more implementations.

An operation 404 may include aggregating a first pooled value consisting of the segmentation of one or more pixels relative to the first classification in the first layer. Operation 404 may be performed by one or more hardware processors configured by machine-readable instructions including a module that is the same as or similar to value aggregation module 310, in accordance with one or more implementations.

An operation 406 may include providing the first pooled value to a matrix having at least one element attributable to the first pooled value. Operation 406 may be performed by one or more hardware processors configured by machine-readable instructions including a module that is the same as or similar to value providing module 312, in accordance with one or more implementations.

An operation 408 may include providing an intensity score for the image based on the first pooled value of the matrix. Operation 408 may be performed by one or more hardware processors configured by machine-readable instructions including a module that is the same as or similar to intensity score providing module 314, in accordance with one or more implementations.

An operation 410 may include storing the image when the first pooled value is less than or equal to a second pooled value. Operation 410 may be performed by one or more hardware processors configured by machine-readable instructions including a module that is the same as or similar to image storing module 316, in accordance with one or more implementations.

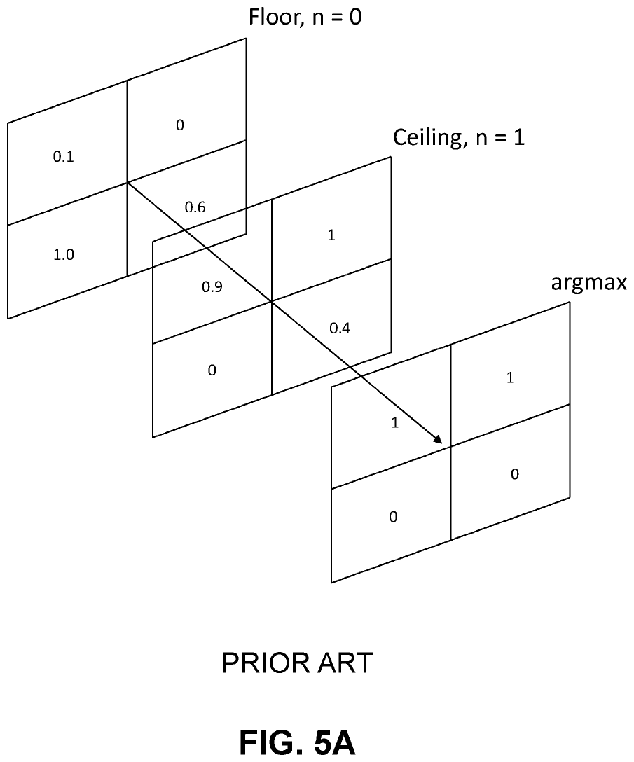

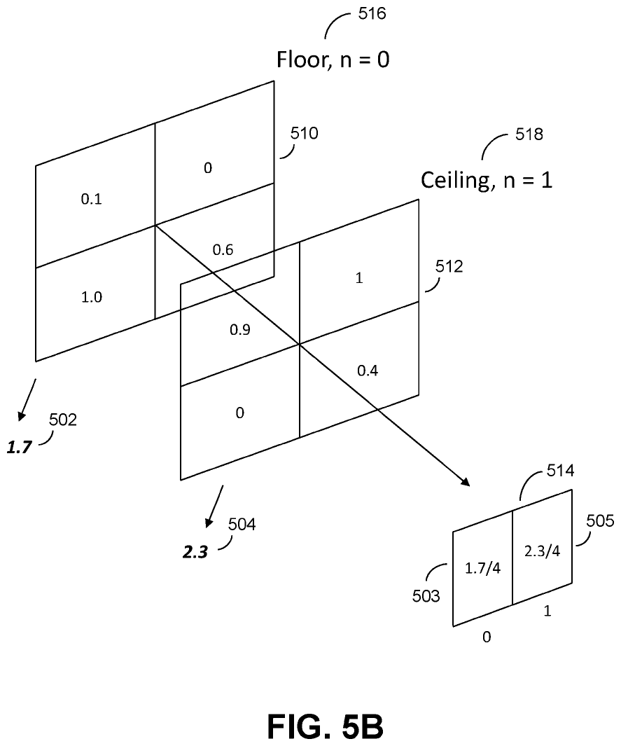

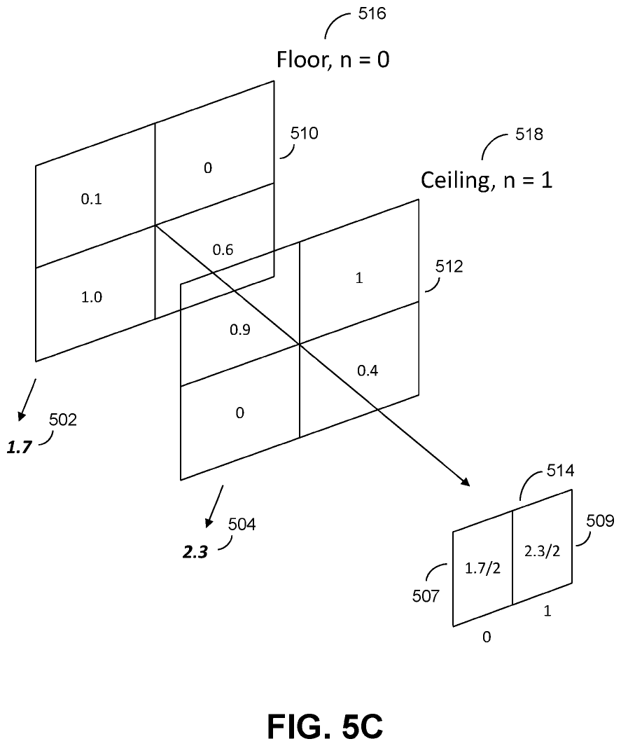

FIG. 5B illustrates a network configuration in accordance with one or more implementations. Similar to FIG. 5A, FIG. 5B illustrates a simple two-layer inference network having layer 510 and layer 512, for an image with a 2×2 pixel resolution to predict the presence of a classification at a particular pixel. Instead of determining the layer where the maximum value lies, as with conventional semantic segmentation, an intra-layer value is pooled for each index. As illustrated in FIG. 5B, all values in layer 510 are summed to produce intra-layer value 502 of 1.7 for index 516 (the floor layer); all values in layer 512 are summed to produce intra-layer value 504 of 1.7 for index 518 (the ceiling layer). In some embodiments, a subset of the layer's predicted values is used as input for an intra-layer value. In some embodiments, the number of pixels used as input for an intra-layer value is the number of pixels in the layer with a predicted value greater than 1/n (where n is the number of layers of the inference network). In some embodiments, the number of pixels used as input for an intra-layer value is the number of pixels in the layer with a value equal to or greater than 0.5.

In some implementations, these intra-layer values may be used to determine whether the image frame comprises enough pixel intensity belonging to a particular class for a given use case. In some implementations, the intra-layer values are further adjusted to determine an intensity score of the classification in said image frame. In some embodiments, the intensity score divides the intra-layer value by a number of pixels in the image frame. In some embodiments, the intensity score divides the intra-layer value by a number of layers in the inference network.

In some implementations, the value related to each layer's intra-layer pooled value populates a new data structure 514. As illustrated in FIG. 5B, a 1×2 data array 514 is populated for the two-classification layers of the network, the 0 channel corresponding to the floor layer 516 (index n=0) and its intensity score 503, and the 1 channel corresponding to the ceiling layer 518 (index n=1) and its intensity score 505.

The multi-cell data array 514 thus provides an aggregate image score indicating the intensity or likelihood of the classified objects in a respective frame (and the intensity indicates how much of that image likely comprises the respective classification) and provides its values as a classification for the real-world image itself. FIG. 5B, for example, indicates the likelihood that the real-world image frame sees both a floor and a ceiling.

In some implementations, an intensity score indicative of likelihood the classified object is in the image is responsive to the resolution of the image. In the low resolution 2×2 image, an intensity score of approximately 0.25 for a respective layer indicates the image likely comprises pixels the classification that layer is configured to detect. As resolution increases, the intensity needed may correspondingly decrease. In a 512×512 pixel image, the intensity score may be as low as 0.05 for an intra-layer value to qualify as sufficiently comprising pixels associated with the appliable classification. These intensity levels may be qualifying intra-level values or intensity scores based on intra-layer values in some implementations.

In some implementations, communication with additional processing units, such as a central processing unit, is initiated and additional processing of the real-world image is activated by the other processing units in response to an image meeting a qualifying intra-level value or intensity score. For example, rather than direct CPU resources to segmenting an image to determine where certain classifications are, the implementations described herein reserve those computing resources until such time as an intra-level value or intensity score indicates the likelihood that the classification is sufficiently present.

In some implementations, real-world images with qualifying intra-layer values or intensity scores may be sent to other data sets, such as for training data for configuring inference networks or three-dimensional reconstruction.

FIG. 5C illustrates a similar configuration as illustrated by FIG. 5B, except the intensity scores 507 and 509 of multi-cell data array 514 are modifications to intra-level value 502 and 504 respectively, according to the number of layers of the associated inference network In some implementations, an intensity score indicative of likelihood the classified object is in the image is responsive to the number of layers in the image. In the low number of layers, such as 2 depicted by FIG. 5C, an intensity score of approximately 0.5 for a respective layer indicates the image likely comprises pixels the classification that layer is configured to detect. As the number of layers increases, the intensity score needed to qualify the image as sufficiently comprising enough pixels related to the classification of a particular layer may correspondingly decrease. In a 4 layer inference network, the intensity score may be as low as 0.1 to qualify as sufficiently comprising pixels associated with the appliable classification. These intensity levels may be qualifying intra-level values or intensity scores based on intra-layer values in some implementations.

In some implementations, communication with additional processing units, such as a central processing unit, is initiated and additional processing of the real-world image is activated by the other processing units in response to an image meeting a qualifying intra-level value or intensity score. For example, rather than direct CPU resources to segmenting an image to determine where certain classifications are, the implementations described herein reserve those computing resources until such time as an intra-level value or intensity score indicates the likelihood that the classification is sufficiently present.

In some implementations, real-world images with qualifying intra-layer values or intensity scores may be sent to other data sets, such as for training data for configuring inference networks or three-dimensional reconstruction.

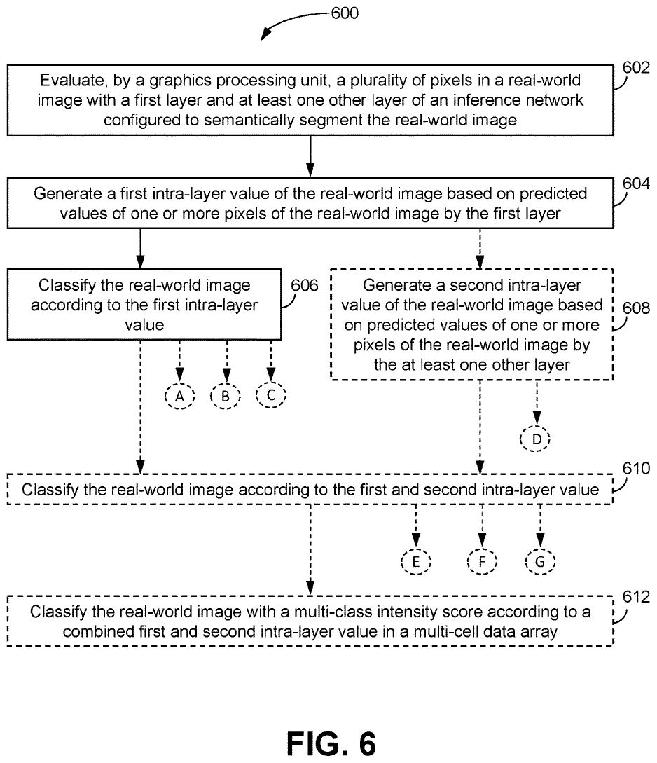

FIG. 6 illustrates a method 600 for evaluating pixels of real-world image by an inference network to determine the degree the real-world image depicts pixels belongs to a particular classification associated with the layers of the inference network according to one or more implementations. Method 600 begins by evaluating 602 a plurality of pixels in the real-world image according to a first classification category using a first layer of an inference network and at least one other classification category according to at least one other layer of the inference network, wherein the inference network is configured to predict a single classification for each pixel among all layers' evaluations.

Based on the evaluation of the pixels, a first intra-layer value is created 604 from one or more predicted values by the first layer of the inference network. A predicted value indicates the likelihood the pixel belongs to the layer's classification relative to the likelihood it belongs to the classification of other layers in the inference network. Though a predicted value itself may be a function of the prediction of the pixel's likelihood of representing objects belonging to other classifications, the first intra-layer is created from only those predicted values associated with the first layer. In creating the first intra-layer value, all pixel's predicted value according to the first layer may be aggregated in several ways. In some implementations, all pixels' predicted values according to the first layer are summed together. In some implementations, only certain predicted value are used to create an intra-layer value. In some implementations, only those predicted values greater than or equal to 0.5 are summed together, in some implementations only those predicted values greater than or equal to 1 divided by the number of layers in the inference network are summed together. As the choice of predicted values gets more selective, the intra-layer value represents decreasing generality about the presence of the classified object in the real-world image, but also increases the confidence of the intra-layer value representing the likelihood of the classified object appearing in the real-world image.

The real-world image may be classified 606 according to its intra-layer value. Classification may indicate the degree, or relative intensity as compared to other classification categories, the classified object is present in the image.

In some implementations, the method continues by creating 608 a second intra-layer value consisting of one or more predicted values by the at least one other layer of the inference network, such layer being associated with its own classification category. A predicted value by the one other layer of the inference network indicates the likelihood the pixel belongs to that layer's classification relative to the likelihood it belongs to the classification of other layers in the inference network (including the first layer)

In some implementations, the real-world image is classified 610 according to the first and second intra-layer values.

The first and second intra-layer values may be combined 612 in a multi-cell data array structure, each cell of the multi-cell data array being associated with the intra-level value or an intensity score of the layer of the inference network. In some implementations, the multi-cell data array is a classification of the real-world image.

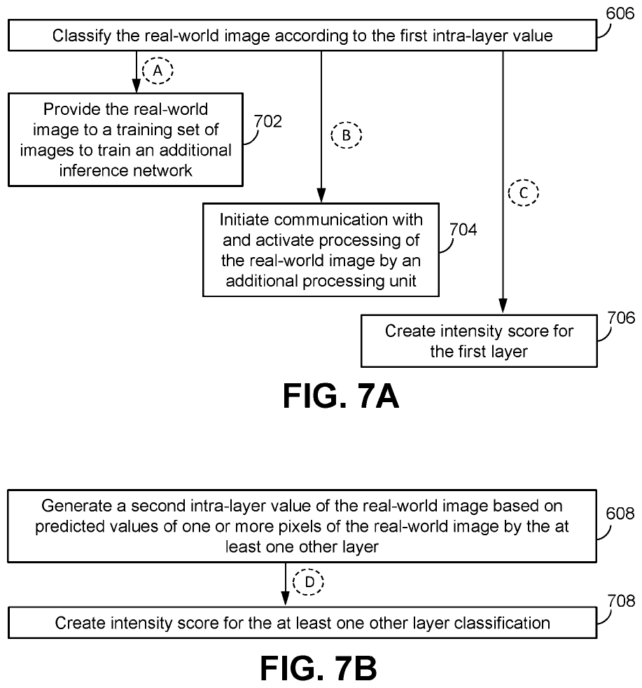

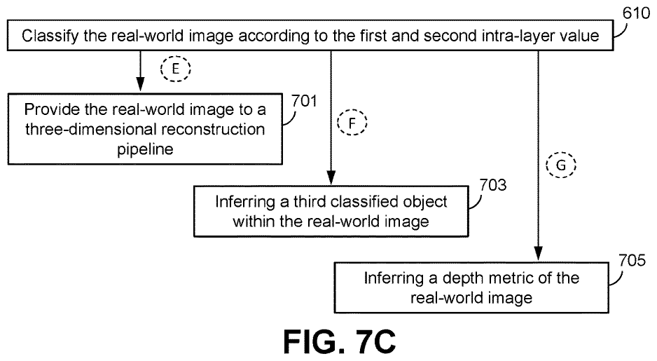

FIG. 7A illustrates certain post-evaluation steps according to one or more implementations. In some implementations, the real-world image is provided 702 to a training set of images to train one or more inference networks. In some implementations, providing the real-world image is based on a qualifying value of the first intra-layer value, depending on the intensity diversity desired for the training set. For example, a range of intensity of a classified object and proportion of that object being represented by pixels may be desired. In some implementations, intensity scores closer to 1 may be desired to ensure the real-world images represent a large amount of pixels associated with the classified object; in some implementations, intensity scores closer to 0 may be desired to ensure the real-world images represent fewer pixels associated with the classified object. By having a range of intensities, a network may prevent under-or over-fitting in training against the classification.

In some implementations, the intra-layer value or intensity score initiates communication 704 and activates processing of the real-world image by one or more additional processing units, such as a central processing unit.

In some implementations, an intensity score is created 706 from the first intra-layer value. The intensity score may be a function of parameters of the real-world image, such as a number of pixels within the full resolution of the image frame of the real-world image or may be a parameter of the inference network such as the total number of layers of the inference network or a total number of layers with the genus relating the first layer to other layers' classifications. It will be appreciated that the operations illustrated by FIG. 7A are non-exclusive and each of actions 702, 704 and 706 or other actions that occur within method 600 broadly may occur serially, or in combinations of varying sequences. For example, in some implementations, initiating communication 704 with an external processing unit is subsequent to creating 706 an intensity score for such layer.
FIG. 7B illustrates creating 708 an intensity score from the second intra-layer value. The intensity score may be a function of parameters of the real-world image, such as a number of pixels within the full resolution of the image frame of the real-world image or may be a parameter of the inference network such as the total number of layers of the inference network or a total number of layers with the genus relating the particular one of the at least one other layer associated with the second intra-layer value to other layers' classifications.

FIG. 7C illustrates post-evaluation steps according to one or more implementations of providing 701 the real-world image to a three-dimensional reconstruction pipeline. Three-dimensional reconstruction may be improved when certain geometries or classifications are present in an image, and by having indications by way of an intra-layer value or intensity score for the real-world image such pipelines may select such qualifying images for use in three-dimensional operations.

In some implementations, a third classification may be inferred 703 from the classification 610 of the real-world image according to the first and second intra-layer values. For example, from indications of the presence of ceilings and floors it may be inferred that walls and corners where those walls meet are also present in the real-world image due to those objects belonging to classifications in a similar genus as the first and second classifications that the first and second intra-layer values are associated with.

In some implementations, a depth metric for the real-world image may be inferred 705. From indications of the presence of ceilings and floors it may be inferred that an image capture device that captured the real-world image is a sufficient distance from other geometries that are valuable for three-dimensional reconstruction.

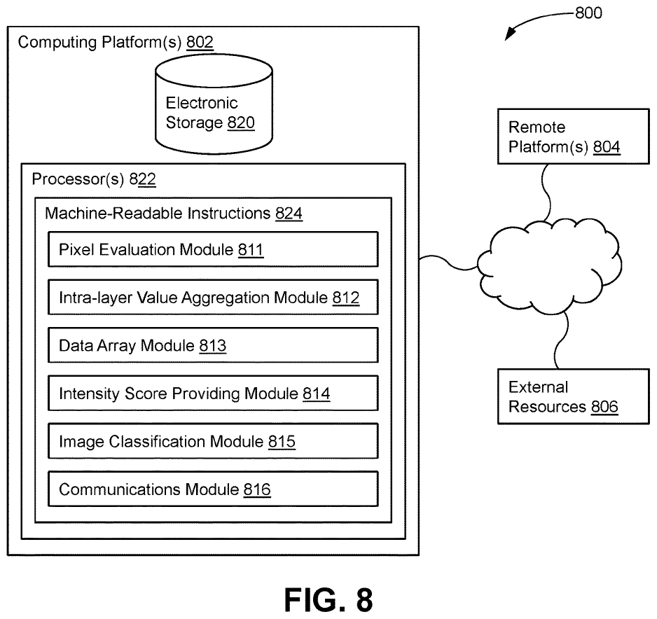

FIG. 8 illustrates a system 800 configured for using a graphics processing unit to evaluate a real-world image for a degree that pixels in the real-world image represent a particular classification, or otherwise classifying an image for an intensity of an object, in accordance with one or more implementations. In some implementations, system 800 may include one or more computing platforms 802. Computing platform(s) 802 may be configured to communicate with one or more remote platforms 804 according to a client/server architecture, a peer-to-peer architecture, and/or other architectures. Remote platform(s) 804 may be configured to communicate with other remote platforms via computing platform(s) 802 and/or according to a client/server architecture, a peer-to-peer architecture, and/or other architectures. Users may access system 800 via remote platform(s) 804.

Computing platform(s) 802 may be configured by machine-readable instructions 824. Machine-readable instructions 824 may include one or more instruction modules. The instruction modules may include computer program modules. The instruction modules may include one or more of pixel evaluation module 811, intra-layer value aggregation module 812, data array module 813, intensity score providing module 814, image classification module 815, communications module 816, and/or other instruction modules.

Pixel evaluation module 811 may be configured to evaluate a plurality of pixels in the image according to a first classification using a first layer of an inference network. In some implementations, pixel evaluation module 811 uses a first layer of an inference network that was configured to produce a single exclusive pixel prediction among multiple layers to make a relative prediction of the likelihood the pixel belongs to the classification category of the first layer. The first classification may be a first surface, such as a floor or other ground surface. The first classification or layer may be associated with a particular genus of classifications. For example, the layers of the inference network may be directed to related classifications belonging to the genus. A first layer may be associated with a first type of classification of the genus, such as a building floors within a building object geometry genus and other layers may be associated with additional classifications in the genus, such as room ceilings within the building object genus.

Pixel evaluation module 811 may be configured to segment the plurality of pixels in the image according to a second classification using a second layer of an inference network. The second classification may be related to a second classification within the same genus as the first layer's classification. The second classification may be a second surface. The second surface may be a ceiling. The second surface may be a roof facet. The second surface may be a floor.

Intra-layer value aggregation module 812 may be configured to pool and create the intra-layer values according to a particular layer's evaluation, for example by summing one or more predicted values of the layer together. Intra-layer value aggregation module 812 may be configured to pool and create first and second intra-layer values.

Data array module 813 may be configured to combine the first intra-layer value with the second intra-layer value, or their respective intensity scores, into a data structure based on the number of layers of the inference network or number of layers related to a particular genus of classifications. Data array module 813 may thus create a multi-class classification value based on the first intra-layer value with the second intra-layer value, or their respective intensity scores Intensity score providing module 814 may be configured to provide one or more intensity scores for the real-world image by modifying the first or second intra-layer value based on an instant parameter, such as the number of pixels in the image or number of layers. Modifying may include dividing the intra-layer value by the respective instant parameter.

Image classification module 815 may be configured to classify the image according to its intra-layer value or intensity score, such as by providing an indication of the intensity of one or more classifications in the image, a depth metric that may be inferred from the image, or the presence of certain objects that were not among the layers of the inference network.

Communications module 816 may be configured to interact with remote platform 804 or external resources 806, such as by initiating communication with additional processing units to perform additional operations on the real-world image, populate training sets, or deliver the real-world image to a three-dimensional reconstruction pipeline.

In some implementations, all of the machine readable instructions may be performed on a graphics processing unit as one of processors 822.

In some implementations, computing platform(s) 802, remote platform(s) 804, and/or external resources 806 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 802, remote platform(s) 804, and/or external resources 806 may be operatively linked via some other communication media.

A given remote platform 804 may include one or more processors configured to execute computer program modules. The computer program modules may be configured to enable an expert or user associated with the given remote platform 804 to interface with system 800 and/or external resources 806, and/or provide other functionality attributed herein to remote platform(s) 804. By way of non-limiting example, a given remote platform 804 and/or a given computing platform 802 may include one or more of a server, a desktop computer, a laptop computer, a handheld computer, a tablet computing platform, a NetBook, a Smartphone, a gaming console, and/or other computing platforms.

External resources 806 may include sources of information outside of system 800, external entities participating with system 800, or other resources such as a central processing unit (CPU). In some implementations, some or all of the functionality attributed herein to external resources 806 may be provided by resources included in system 800.

Computing platform(s) 802 may include electronic storage 820, one or more processors 822, and/or other components. Computing platform(s) 802 may include communication lines, or ports to enable the exchange of information with a network and/or other computing platforms. Illustration of computing platform(s) 802 in FIG. 8 is not intended to be limiting. Computing platform(s) 802 may include a plurality of hardware, software, and/or firmware components operating together to provide the functionality attributed herein to computing platform(s) 802. For example, computing platform(s) 802 may be implemented by a cloud of computing platforms operating together as computing platform(s) 802.

Electronic storage 820 may comprise non-transitory storage media that electronically stores information. The electronic storage media of electronic storage 820 may include one or both of system storage that is provided integrally (i.e., substantially non-removable) with computing platform(s) 802 and/or removable storage that is removably connectable to computing platform(s) 802 via, for example, a port (e.g., a USB port, a firewire port, etc.) or a drive (e.g., a disk drive, etc.). Electronic storage 820 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 820 may include one or more virtual storage resources (e.g., cloud storage, a virtual private network, and/or other virtual storage resources). Electronic storage 820 may store software algorithms, information determined by processor(s) 822, information received from computing platform(s) 802, information received from remote platform(s) 804, and/or other information that enables computing platform(s) 802 to function as described herein.

Processor(s) 822 may be configured to provide information processing capabilities in computing platform(s) 802. As such, processor(s) 822 may include one or more of a digital processor, an analog processor, a digital circuit designed to process information, an analog circuit designed to process information, a state machine, and/or other mechanisms for electronically processing information. Although processor(s) 822 is shown in FIG. 8 as a single entity, this is for illustrative purposes only. In some implementations, processor(s) 822 may include a plurality of processing units. These processing units may be physically located within the same device, or processor(s) 822 may represent processing functionality of a plurality of devices operating in coordination. Processor(s) 822 may be configured to execute modules 811, 812, 813, 814, 815, and/or 816, and/or other modules. Processor(s) 822 may be configured to execute modules 811, 812, 813, 814, 815, and/or 816, and/or other modules by software; hardware; firmware; some combination of software, hardware, and/or firmware; and/or other mechanisms for configuring processing capabilities on processor(s) 822. As used herein, the term “module” may refer to any component or set of components that perform the functionality attributed to the module. This may include one or more physical processors during execution of processor readable instructions, the processor readable instructions, circuitry, hardware, storage media, or any other components.

One or more implementations are further expressed according to the following examples.

In an example, a method of evaluating a real-world image for a sufficiency of pixels representing a particular classification category of the real-world image is described, the method comprising evaluating a plurality of pixels in the image according to a first classification category using a first layer of an inference network and a second classification category using a second layer of the inference network, wherein the inference network is configured to predict a single classification value for each pixel based on the first and second layers. The classification value of a respective first and second layer may be aggregated into a respective first and second pooled value, wherein the first and second pooled values consist of the evaluation of one or more pixels by the respective layer. The first and second pooled values may be combined into a data array representing a total number of layers for the inference network. One or more multiple-class intensity scores for the image may be provided according to the combined first and second pooled value of the data array. The real-world image may be classified according to the first or second pooled value, or the multiple-class intensity scores.

In an example, each of the evaluating and combining are performed on a graphics processing unit.

In an example, the first classification category and second classification category are related categories under a genus classification, such as building geometries like eave lines, rooflines, ceilings, floors, posts, and other structurally-related geometries or objects.

In an example, the first classification category is a first surface.

In an example, the first surface is a floor. In an example, the first surface is a ground surface. In an example, the first surface is a ceiling. In an example, the first surface is a roof facet.

In an example, the second classification category is a second surface.

In an example, the second surface is a ceiling. In an example, the second surface is a roof facet. In an example, the second surface is a floor. In an example, the second surface is a ground surface.

In an example, combining the first pooled value with the second pooled value comprises respectively populating a matrix comprising elements for at least the first pooled value and the second pooled value.

In an example, providing the one or more multiple-class intensity scores further comprises modifying the first pooled value based on the number of pixels in the image. In an example, modifying the first pooled value comprises dividing the first pooled value by the number of pixels in the image. In an example, modifying the first pooled value comprises dividing the first pooled value by the number of layers in the inference network.

In an example, providing the one or more multiple-class intensity scores further comprises modifying the second pooled value based on the number of pixels in the image. In an example, modifying the second pooled value comprises dividing the second pooled value by the number of pixels in the image. In an example, modifying the second pooled value comprises dividing the second pooled value by the number of layers in the inference network.

In an example, the real-world image is provided to a three-dimensional reconstruction pipeline based on the first and second pooled values.

In an example, the real-world image is provided to a training set to configure an additional inference network, or further refine a configuration of any inference network, according to the first and second pooled values.

In an example, additional classifications that did not have an associated layer of the inference network are inferred based on the first and second pooled values. In an example, an inferred additional classification is a corner based on the first and second pooled values being associated with floors or ceilings.

In an example, a distance parameter of an image capture device that captured the real-world image is inferred based on the first and second pooled values. In an example, the distance parameter indicates the image capture device was at a prescribed distance or depth in the scene associated with the real-world image.

In an example, a non-transient computer-readable storage medium having instructions embodied thereon, the instructions being executable by one or more processors to perform a method for classifying an image for an intensity of an object is described.

In an example, the method segments a plurality of pixels in the image according to a first classification using a first layer of an inference network, segments the plurality of pixels in the image according to a second classification using a second layer of an inference network, aggregates a first pooled value consisting of the segmentation of one or more pixels relative to the first classification in the first layer, aggregates a second pooled value consisting of the segmentation of one or more pixels relative to the second classification in the second layer, combines the first pooled value with the second pooled value, provides one or more multiple-class intensity scores for the image using the combined first pooled value and second pooled value, and tags the image concurrent with the second pooled value exceeding the first pooled value.

In an example, according to the instructions of the non-transient computer-readable storage medium, each of the segmenting and combining are performed on a graphics processing unit.

In an example, according to the instructions of the non-transient computer-readable storage medium, the first classification and second classification are related categories under a genus classification, such as building geometries like eave lines, rooflines, ceilings, floors, posts, and other structurally-related geometries or objects.

In an example, according to the instructions of the non-transient computer-readable storage medium, the first classification is a first surface.

In an example, according to the instructions of the non-transient computer-readable storage medium, the first surface is a floor. In an example, according to the instructions of the non-transient computer-readable storage medium, the first surface is a ground surface. In an example, according to the instructions of the non-transient computer-readable storage medium, the first surface is a ceiling. In an example, according to the instructions of the non-transient computer-readable storage medium, the first surface is a roof facet.

In an example, according to the instructions of the non-transient computer-readable storage medium, the second classification is a second surface.

In an example, according to the instructions of the non-transient computer-readable storage medium, the second surface is a ceiling. In an example, according to the instructions of the non-transient computer-readable storage medium, the second surface is a roof facet. In an example, according to the instructions of the non-transient computer-readable storage medium, the second surface is a floor. In an example, according to the instructions of the non-transient computer-readable storage medium, the second surface is a ground surface.

In an example, according to the instructions of the non-transient computer-readable storage medium, combining the first pooled value with the second pooled value comprises respectively populating a matrix comprising elements for at least the first pooled value and the second pooled value.

In an example, according to the instructions of the non-transient computer-readable storage medium, providing the one or more multiple-class intensity scores further comprises modifying the first pooled value based on the number of pixels in the image. In an example, according to the instructions of the non-transient computer-readable storage medium, providing the one or more multiple-class intensity scores further comprises modifying the first pooled value based on the number of layers in the inference network.

In an example, according to the instructions of the non-transient computer-readable storage medium, modifying the first pooled value comprises dividing the first pooled value by the number of pixels in the image. In an example, according to the instructions of the non-transient computer-readable storage medium, modifying the first pooled value comprises dividing the first pooled value by the number of layers in the inference network.

In an example, according to the instructions of the non-transient computer-readable storage medium, providing the one or more multiple-class intensity scores further comprises modifying the second pooled value based on the number of pixels in the image. In an example, according to the instructions of the non-transient computer-readable storage medium, providing the one or more multiple-class intensity scores further comprises modifying the second pooled value based on the number of layers in the inference network.

In an example, according to the instructions of the non-transient computer-readable storage medium, modifying the second pooled value comprises dividing the second pooled value by the number of pixels in the image. In an example, according to the instructions of the non-transient computer-readable storage medium, modifying the second pooled value comprises dividing the second pooled value by the number of layers in the inference network.

In an example, according to the instructions of the non-transient computer-readable storage medium, the image is provided to a three-dimensional reconstruction pipeline based on the first and second pooled values.

In an example, according to the instructions of the non-transient computer-readable storage medium, the image is provided to a training set to configure an additional inference network, or further refine a configuration of any inference network, according to the first and second pooled values.

In an example, according to the instructions of the non-transient computer-readable storage medium, additional classifications that did not have an associated layer of the inference network are inferred based on the first and second pooled values. In an example, according to the instructions of the non-transient computer-readable storage medium, an inferred additional classification is a corner based on the first and second pooled values being associated with floors or ceilings.

In an example, according to the instructions of the non-transient computer-readable storage medium, a distance parameter of an image capture device that captured the image is inferred based on the first and second pooled values. In an example, according to the instructions of the non-transient computer-readable storage medium, the distance parameter indicates the image capture device was at a prescribed distance or depth in the scene associated with the image.

In an example, a system configured for classifying an image for an intensity of an object is described. In an example, the system comprises one or more hardware processors configured by machine-readable instructions to segment a plurality of pixels in the image according to a first classification using a first layer of an inference network, segment the plurality of pixels in the image according to a second classification using a second layer of an inference network, aggregate a first pooled value consisting of the segmentation of one or more pixels relative to the first classification in the first layer, aggregate a second pooled value consisting of the segmentation of one or more pixels relative to the second classification in the second layer combine the first pooled value with the second pooled value, provide one or more multiple-class intensity scores for the image using the combined first pooled value and second pooled value, and store the image when the first pooled value is less than or equal to the second pooled value.

In an example, the system is segments according to a respective layer and combines the pooled values produced by a respective layer with a graphics processing unit.

In an example, the first classification and second classification the system is configured to operate with are related categories under a genus classification, such as building geometries like eave lines, rooflines, ceilings, floors, posts, and other structurally-related geometries or objects.

In an example, first classification within the system is a first surface.

In an example, the first surface of the system's first classification is a floor. In an example, the first surface is a ground surface. In an example, the first surface is a ceiling. In an example, the first surface is a roof facet.

In an example, the second classification within the system is a second surface.

In an example, the first surface of the system's second classification is a ceiling. In an example, the second surface is a roof facet. In an example, the second surface is a floor. In an example, the second surface is a ground surface.

In an example, the system is configured to combine the first pooled value with the second pooled value by populating a matrix comprising elements for at least the first pooled value and the second pooled value.

In an example, the system is configured to provide the one or more multiple-class intensity scores by modifying the first pooled value based on the number of pixels in the image. In an example, the system is configured to provide the one or more multiple-class intensity scores by modifying the first pooled value based on the number of layers in the inference network.

In an example, the system modifies the first pooled value by dividing the first pooled value by the number of pixels in the image. In an example, the system modifies the first pooled value by dividing the first pooled value by the number of layers in the network.

In an example, the system is configured to provide the one or more multiple-class intensity scores by modifying the second pooled value based on the number of pixels in the image. In an example, the system is configured to provide the one or more multiple-class intensity scores by modifying the second pooled value based on the number of layers in the inference network.

In an example, the system modifies the second pooled value by dividing the second pooled value by the number of pixels in the image. In an example, the system modifies the second pooled value by dividing the second pooled value by the number of layers in the network.

In an example, the system provides the image to a three-dimensional reconstruction pipeline based on the first and second pooled values.

In an example, the system provides the image to a training set to configure an additional inference network, or further refine a configuration of any inference network, according to the first and second pooled values.

In an example, the system infers additional classifications that did not have an associated layer of the inference network based on the first and second pooled values. In an example, an inferred additional classification by the system is a corner based on the first and second pooled values being associated with floors or ceilings.

In an example, the system infers a distance parameter of an image capture device that captured the image based on the first and second pooled values. In an example, the distance parameter indicates the image capture device was at a prescribed distance or depth in the scene

### Associated With the Image.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method of using a graphics processing unit to evaluate a real-world image for a degree that pixels in the real-world image represent a particular classification category, the method comprising:
evaluating a plurality of pixels in the real-world image according to a first classification category using a first layer of an inference network and at least one other classification category according to at least one other layer of the inference network, wherein the inference network is configured to predict a single classification for each pixel among all layers' evaluations;
creating a first intra-layer value based on summing inputs consisting of predicted values for one or more pixels of the real-world image by the first layer, wherein a predicted value for any one pixel of the plurality of pixels by the first layer is based on a relative comparison of the evaluation of the pixel by the first layer of the inference network relative to the evaluation of the same pixel by the at least one other layer;
and classifying the real-world image according to the first intra-layer value.

2. The method of claim 1, further comprising:
creating a second intra-layer value based on summing inputs consisting of predicted values for one or more pixels of the real-world image by one of the at least one other layers, wherein a predicted value for any one pixel of the plurality of pixels by the one of the at least one other layer is based on a relative comparison of the evaluation of the pixel by the one of the at least one other layer of the inference network relative to the evaluation of the same pixel by the first layer.

3. The method of claim 2, wherein classifying the real-world image further comprises classifying according to the second intra-layer value.

4. The method of claim 3, further comprising selecting the real-world image for three-dimensional reconstruction responsive to the first and second intra-layer values.

5. The method of claim 3, wherein the first classification and at least one other classification are related classifications within a genus of building object classification types.

6. The method of claim 5, where the first classification is a ceiling surface of a room, and one of the at least one other classifications is a floor surface of a room.

7. The method of claim 6, further comprising inferring, from the classification according to the first and second intra-layer values, a third classified object within the real-world image, wherein the third classification is a corner defined by two or more planes intersecting.

8. The method of claim 6, further comprising validating a depth metric for the real-world image in response to the classification of the real-world image according to the ceiling surface and floor surface classifications of the real-world image.

9. The method of claim 3, wherein classifying the image further comprises providing the first and second intra-layer values to a one-dimensional multi-cell data array comprising a number of cells based on the number of layers of the inference network, wherein the one-dimensional multi-cell data array combines the first and second intra-layer values as a multi-class intensity score for the real-world image.

10. The method of claim 1, wherein creating the first intra-layer value further comprises generating an intensity score for the first classification, wherein the intensity score expresses the intra-layer value according to an instant parameter of the real-world image.

11. The method of claim 1, wherein creating the first intra-layer value further comprises generating an intensity score for the first classification score, wherein the intensity score expresses the intra-layer value according to an instant parameter of the inference network.

12. The method of claim 1, further comprising providing the real-world image to a training set of images to configure an additional inference network, wherein the providing is responsive to the first intra-layer value of the real-world image.

13. The method as in any one of claims 1 or 2, wherein summing inputs consisting of predicted values for one or more pixels comprises summing only those pixels with a predicted value over 0.5.

14. The method as in any one of claims 1 or 2, wherein summing inputs consisting of predicted values for one or more pixels comprises summing only those pixels with a predicted value over 1/n, wherein n is the number of layers of the network.

15. The method as in any one of claims 1 or 2, wherein summing inputs consisting of predicted values for one or more pixels comprises summing all pixel's predicted values.

16. The method as in any one of claims 1 or 10, wherein the first intra-layer value or intensity score expresses the comparative probability that pixels in the real-world image are associated with the classification of the first layer relative to the classification category of the at least one other layer's.

17. The method as in any one of claims 2 or 11, wherein the second intra-layer value or intensity score expresses the comparative probability that pixels in the real-world image are associated with the classification of the at least one other layer relative to all other classification categories of the inference network's other layers.

18. The method of any one of claims 1-15, further comprising initiating communication with a central processing unit to semantically segment the real-world image, the communication initiated in response to classifying the image with a qualifying intra-layer value.

19. A system comprising a memory and a graphics processing unit, wherein the system is configured to perform operations as in any one of claims 1-16.

20. One or more non-transient computer readable storage medium having instructions embedded thereon, the instructions executable to perform a method of using a graphics processing unit to evaluate a real-world image for a degree that pixels in the real-world image represent a particular classification category as in any one of claims 1-16.
